(19) United States
(12) Patent Application Publication
(10) Pub. No.: US 2019/0302739 A1
(43) Pub. Date: Oct. 3, 2019

(54) PROGRAM VERIFICATION SYSTEM, CONTROL APPARATUS, AND PROGRAM VERIFICATION METHOD

(71) Applicant: Mitsubishi Electric Corporation, Tokyo (JP)

(72) Inventors: Takayuki SUZUKI, Tokyo (JP); Takuto YOSHIFUJI, Tokyo (JP)

(73) Assignee: Mitsubishi Electric Corporation, Tokyo (JP)

(21) Appl. No.: 16/316,484

(22) PCT Filed: Jun. 23, 2017
(86) PCT No.: PCT/JP2017/023134

§ 371 Date: Jan. 9, 2019

(51) Int. Cl. G05B 19/4155; G06F 13/20

(52) U.S. Cl. CPC G05B 19/4155; G06F 2213/40; G05B 2219/31362; G06F 13/20

(57) ABSTRACT

A program verification system includes a PLC that calculates control output data corresponding to control input data by using a control program for controlling an apparatus to be controlled, and outputs the control output data to an input/output device, and a collation unit that performs operation verification of the control program by collating test output data included in a test pattern, which is a combination of test input data and the test output data satisfying operation specifications of the apparatus to be controlled and indicates a temporal change, with the control output data calculated by the PLC, and the PLC includes a control unit that, when operation verification of the control program is performed, if there is an instruction to refer to the control input data in the control program, generates first time information in the PLC, extracts the test input data corresponding to the first time information from the test pattern, and calculates control output data by using the extracted test input data and the control program.

### FIELD

The present invention relates to a program verification system, a control apparatus, and a program verification method for verifying a control program used for controlling an apparatus.

### BACKGROUND

A control apparatus such as a programmable logic controller (PLC) stores various kinds of data, and it uses stored data to operate a control program for controlling an apparatus. As a result, the PLC controls an apparatus or a facility including the PLC incorporated therein at specific intervals.

Such a control program is designed on the basis of operation specifications of an apparatus in which the PLC is incorporated, and operation verification is performed by using an actual machine such as an apparatus or a facility. The operation verification apparatus described in Patent Literature 1 detects a program portion having a function of inputting or outputting a control signal to or from a sequencer as a PLC from among robot operation programs as control programs. Then, the operation verification apparatus described in Patent Literature 1 changes an internal state of the sequencer by sequentially inputting the detected program portion to the sequencer, and verifies the operation of the sequencer on the basis of this change.

### CITATION LIST

### Patent Literature

Patent Literature 1: Japanese Patent Application Laid-open No. H10-97307

### SUMMARY

### Technical Problem

However, in the above-described conventional technique, Patent Literature 1, time information is not considered in the operation verification, so that it is not possible to operate the apparatus with high accuracy. Consequently, there is a problem in that accurate operation verification of the control program cannot be performed in the above-described conventional technique, Patent Literature 1.

The present invention has been made in view of the above, and an object thereof is to obtain a program verification system capable of performing accurate operation verification of a control program.

### Solution to Problem

In order to solve the above-described problems and achieve the object, the present invention includes, in a program verification system, a control apparatus that receives input of control input data from an input/output device that inputs and outputs data, calculates control output data corresponding to the control input data by using a control program for controlling an apparatus, and outputs the control output data to the input/output device; and a collation unit that performs operation verification of the control program by collating test output data included in a test pattern, which is a combination of test input data and the test output data satisfying operation specifications of the apparatus and indicates a temporal change, with the control output data calculated by the control apparatus. In addition, in the program verification system of the present invention, the control apparatus includes a storage unit that stores the test pattern; and a control unit that, when operation verification of the control program is performed, if there is an instruction to refer to the control input data in the control program, acquires first time information that is information on time in the control apparatus, extracts the test input data corresponding to the first time information from the test pattern, and calculates the control output data by using the extracted test input data and the control program.

### Advantageous Effects of Invention

The program verification system according to the present invention has an effect that accurate operation verification of a control program can be performed.

### BRIEF DESCRIPTION OF DRAWINGS

FIG. 1 is a diagram illustrating a configuration of a program verification system according to an embodiment of the present invention.

FIG. 2 is a diagram illustrating a configuration of a storage unit included in a PLC according to the embodiment.

FIG. 3 is a diagram illustrating an operation specification example of an apparatus according to the embodiment.

FIG. 4 is a diagram illustrating an example of a test pattern according to the embodiment.

FIG. 5 is a flowchart illustrating an operation procedure of the PLC according to the embodiment.

FIG. 6 is a diagram for explaining a difference between operation verification using an actual machine and operation verification according to the embodiment.

FIG. 7 is a diagram illustrating an example hardware configuration of a control unit included in the PLC according to the embodiment.

### DESCRIPTION OF EMBODIMENTS

Hereinafter, a program verification system, a control apparatus, and a program verification method according to an embodiment of the present invention will be described in detail with reference to the drawings. The invention is not limited to the embodiment.

### Embodiment

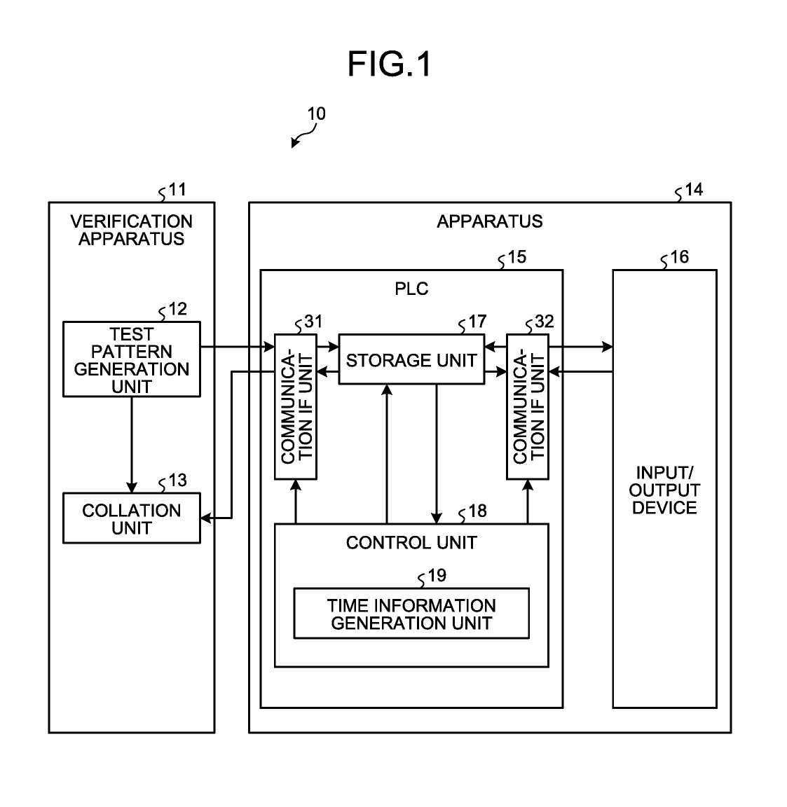

FIG. 1 is a diagram illustrating a configuration of a program verification system according to an embodiment of the present invention. The program verification system 10 includes an apparatus 14 such as a machine tool or a semiconductor manufacturing apparatus, and a verification apparatus 11 that verifies a control program used for controlling the apparatus 14.

The apparatus 14 includes a PLC 15 as a control apparatus for controlling the apparatus 14 and an input/output device 16 that inputs and outputs data to and from the PLC 15. The PLC 15 includes a storage unit 17 that stores various kinds of information and a control unit 18 that controls the apparatus 14 by using the information in the storage unit 17. The PLC 15 further includes a communication interface (IF) unit 31 that performs data communication with the verification apparatus 11, and a communication IF unit 32 that performs data communication with the input/output device 16.

The communication IF unit 31, which is a first communication unit, performs data communication with the verification apparatus 11 in accordance with an instruction from the control unit 18. The communication IF unit 31 accepts a test pattern sent from the verification apparatus 11 and sends the test pattern to the storage unit 17. The test pattern is data used for verification of the control program. The test pattern satisfies operation specifications of the apparatus 14, and is a combination of input data to be described later and output data to be described later. The test pattern indicates a temporal change in value which can occur within a range defined by the operation specifications of the apparatus 14. That is, the test pattern indicates temporal changes in the input data and the output data defined on the basis of the operation specifications of the apparatus 14 including the PLC 15 incorporated therein or a facility where the PLC 15 is arranged. Specifically, the test pattern is constituted of input data as test input data, output data as test output data, and time information T2 to be described later as information on time, which are associated with one another.

An example of the input data is data input to the PLC 15 by the input/output device 16. The output data is data calculated by the control program in the PLC 15 and is output to the input/output device 16 by the PLC 15. There are two kinds of input data in the input data used by the program verification system 10. Among the two kinds of input data, the input data included in the test pattern is test input data used for verification of the control program. Among the two kinds of input data, the input data input from the input/output device 16 is control input data used for controlling the input/output device 16. There are two kinds of output data in the output data used by the program verification system 10. Among the two kinds of output data, the output data included in the test pattern is test output data used for verification of the control program. Among the two kinds of output data, the output data calculated by the control unit 18 is control output data. When the program verification system 10 performs a dynamic analysis to be described later, the control output data calculated by the control unit 18 is used for collation with the test output data. When the program verification system 10 does not perform the dynamic analysis to be described later, the control output data calculated by the control unit 18 is used for control of the input/output device 16.

The communication IF unit 31 sends a combination of input data used by the control unit 18 and the output data calculated by the control unit 18 by using the control program, to the verification apparatus 11. The communication IF unit 32, which is a second communication unit, performs data communication with the input/output device 16 in accordance with an instruction from the control unit 18. The communication IF unit 32 receives input data sent from the input/output device 16 and sends the input data to the storage unit 17. The communication IF unit 32 sends the output data calculated by the control unit 18 and stored in the storage unit 17 to the input/output device 16.

The storage unit 17 stores input data, output data, a control program, operation setting parameters indicating operation settings of the control unit 18, and a test pattern. An example of the control program is a sequence program such as a ladder program. An example of the operation setting parameters indicating the operation settings of the control unit 18 is a parameter in which whether a dynamic analysis of the control program is performed is specified or a parameter in which a method for acquiring input data at time of operation verification is specified. As the method for acquiring input data at the time of operation verification, there are a method for acquiring all of input data from a test pattern, and a method for acquiring a part of input data from a test pattern and acquiring the remainder thereof from the input/output device 16.

The control unit 18 controls the communication IF units 31 and 32 and the storage unit 17. The control unit 18 includes a time information generation unit 19 that generates time information, which is information on time managed by the PLC 15. The time information generation unit 19 has a clock function, and generates time information by using the clock function. The time information generation unit 19 may be arranged outside the control unit 18.

In the following description, time information in the PLC 15 generated by the time information generation unit 19 is referred to as time information T1. In the following description, information on time in the test pattern is referred to as time information T2. The time information T1 that is first time information may be time elapsed since the PLC 15 is turned ON, or may be information on time and date or time measured by a timepiece. Time information T2 that is second time information is information on time corresponding to the time information T1. Therefore, when the time information T1 is the time elapsed since the PLC 15 is turned ON, the time information T2 is information indicating the elapsed time, and when the time information T1 is the time and the date or time measured by the timepiece, the time information T2 is information indicating the time or the date and time.

The control unit 18 calculates output data to be output to the input/output device 16 by executing the control program. The control unit 18 calculates the output data by applying the input data to the control program. In other words, the control unit 18 calculates the output data corresponding to the input data by using the control program. The control unit 18 calculates the output data by executing the control program with reference to the input data stored in the storage unit 17 or the input data in the input/output device 16. The control unit 18 stores, in the storage unit 17, a combination of the input data and the output data calculated by using the control program.

When controlling a normal operation of the input/output device 16, the control unit 18 calculates output data corresponding to the input data sent from the input/output device 16. In other words, when controlling the normal operation, the control unit 18 calculates control output data corresponding to control input data on the basis of the control input data. In addition, when checking an operation of the control program, the control unit 18 extracts the input data from the test pattern on the basis of the time information T1 generated by the time information generation unit 19. Specifically, the control unit 18 extracts, from the test pattern, the time information T2 that is the same information on time as the time information T1, and it extracts the input data associated with the extracted time information T2 from the test pattern. When checking the operation of the control program, the control unit 18 calculates output data corresponding to the input data extracted from the test pattern. In other words, when checking the operation of the control program, the control unit 18 calculates control output data corresponding to test input data on the basis of the test input data.

The input/output device 16 is a device that inputs and outputs data, and is connected to the PLC 15. The input/output device 16 includes an input device that sends input data to the PLC 15 and an output device that receives output data from the PLC 15.

An example of the input device is an input button or a sensor. In a case where the input device is an input button, when a user presses the input button, the input button sends, to the PLC 15, input data indicating that the input button has been pressed. In a case where the input device is a sensor, the sensor sends input data, which is information such as a temperature or a position which has been detected, to the PLC 15.

An example of the output device is an open/close valve or a light emitting diode (LED). When the output device is an opening/closing valve, the opening/closing valve receives output data for opening the valve or output data for closing the valve from the PLC 15. When the output device is an LED, the LED receives output data for turning on the LED or output data for turning off the LED from the PLC 15.

When input data is input by the input device, the PLC 15 calculates output data corresponding to the input data from the input device by using the control program, and it outputs the calculated output data to the output device. The output data that the PLC 15 sends to the output device is a calculation result of the output data by the control program.

The verification apparatus 11 includes a test pattern generation unit 12 that generates a test pattern and a collation unit 13 that collates the operation of the control program with the test pattern. The test pattern generation unit 12 generates a test pattern on the basis of the operation specifications of the apparatus 14. The test pattern generation unit 12 sends the generated test pattern to the PLC 15 and the collation unit 13.

The test pattern generation unit 12 may send the whole of the generated test pattern to the PLC 15, but may send portions including the input data and the time information T2 of the generated test pattern to the PLC 15. That is, because the PLC 15 uses the input data in the test pattern, the test pattern generation unit 12 may transmit the test pattern excluding a portion corresponding to the output data to the PLC 15. The test pattern generation unit 12 sends the whole of the generated test pattern to the collation unit 13.

The collation unit 13 receives, from the PLC 15, a combination of the input data extracted from the test pattern and the output data corresponding to the extracted input data. The collation unit 13 collates the output data of the PLC 15 with the operation specifications of the apparatus 14. At that time, the collation unit 13 collates a first combination that is a combination of the input data and the output data received from the PLC 15 with a second combination that is a combination of the input data and the output data in the test pattern. Specifically, the collation unit 13 extracts, from the test pattern, the time information T2 that is the same information on time as the time information T1 associated with the first combination, and it extracts, from the test pattern, the second combination corresponding to the extracted time information T2. Then, the collation unit 13 compares the received first combination with the extracted second combination. The collation unit 13 verifies the operation of the control program on the basis of a result of the comparison. When the received first combination and the extracted second combination are the same, the collation unit 13 determines that the control program is created in accordance with the operation specifications of the apparatus 14. The input data and the output data in the test pattern satisfy the operation specifications of the apparatus 14. Therefore, the collation unit 13 of the embodiment verifies the operation of the control program by collating the output data received from the PLC 15 with the output data in the test pattern. In that case, the collation unit 13 extracts output data corresponding to the input data received from the PLC 15 from the test pattern, and compares the extracted output data with the output data received from the PLC 15. On the other hand, when the received first combination and the extracted second combination are different from each other, the collation unit 13 determines that the control program has not been created in accordance with the operation specifications of the apparatus 14. When the output data received from the PLC 15 is different from the output data in the test pattern, the collation unit 13 of the embodiment determines that the control program has not been created in accordance with the operation specifications of the apparatus 14.

The PLC 15 may be arranged outside the apparatus 14. The verification apparatus 11 may be arranged in the apparatus 14. In that case, the test pattern generation unit 12 may be arranged outside the apparatus 14. The verification apparatus 11 may be arranged in the PLC 15. In other words, the PLC 15 may perform operation verification, which is collation between the input/output data of the PLC 15 and the operation specifications of the apparatus 14. In that case, the test pattern generation unit 12 may be arranged outside the PLC 15.

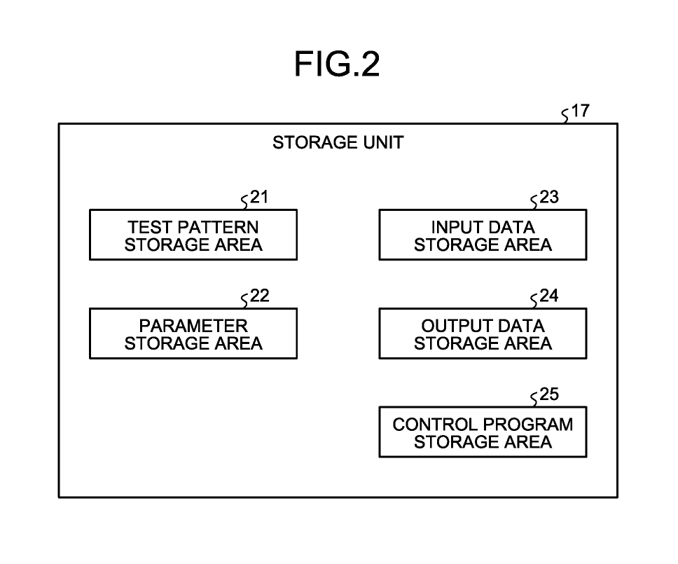

Next, a configuration of the storage unit 17 will be described. FIG. 2 is a diagram illustrating a configuration of a storage unit included in the PLC according to the embodiment. The storage unit 17 includes a test pattern storage area 21 that stores a test pattern and a parameter storage area 22 that stores operation setting parameters. The storage unit 17 further includes an input data storage area 23 that stores input data and an output data storage area 24 that stores output data. The storage unit 17 further includes a control program storage area 25 that stores a control program.

The test pattern storage area 21, which is a first storage unit, is an area where the test pattern sent from the verification apparatus 11 is stored. The parameter storage area 22 is an area where operation setting parameters set by the user of the apparatus 14 are stored.

The input data storage area 23, which is a second storage unit, is an area where the input data used for execution of the control program is stored. When the program verification system 10 verifies the operation of the control program, the control unit 18 stores the input data extracted from the test pattern in the input data storage area 23. In other words, when verifying the operation of the control program, the control unit 18 rewrites some values or all values of the input data to the input data in the test pattern. In that case, the control unit 18 collates the time information T2 included in the test pattern with the time information T1 generated by the time information generation unit 19, and it extracts, from the test pattern, values of the input data for rewriting the input data in the input data storage area 23. On the other hand, when the PLC 15 performs the normal operation using the input/output device 16, the control unit 18 stores, in the input data storage area 23, the input data input to the PLC 15 by the input/output device 16. As described above, when the program verification system 10 verifies the operation of the control program, the input data storage area 23 stores the input data as the test input data, and when the program verification system 10 performs the normal operation, the input data storage area 23 stores the input data as the control input data.

The output data storage area 24, which is a third storage unit, is an area where the output data is stored. Upon calculating the output data corresponding to the input data stored in the input data storage area 23, the control unit 18 stores the calculated output data in the output data storage area 24. When the input data stored in the input data storage area 23 is the input data of the test pattern, the control unit 18 stores the output data corresponding to the input data of the test pattern in the output data storage area 24. On the other hand, when the input data stored in the input data storage area 23 is input data from the input/output device 16, the control unit 18 stores the output data corresponding to the input data from the input/output device 16 in the output data storage area 24. An example of the input data storage area 23 and the output data storage area 24 is a register. As described above, the output data storage area 24 stores the output data as the control output data calculated by using the input data in both of cases where the program verification system 10 verifies the operation of the control program and where the program verification system 10 performs the normal operation.

The control program storage area 25 is an area where a control program sent from an external apparatus such as a program creation apparatus (not illustrated) is stored. The storage unit 17 may be configured with a plurality of storage devices. In the following description, input data and output data may be referred to as input/output data in some cases.

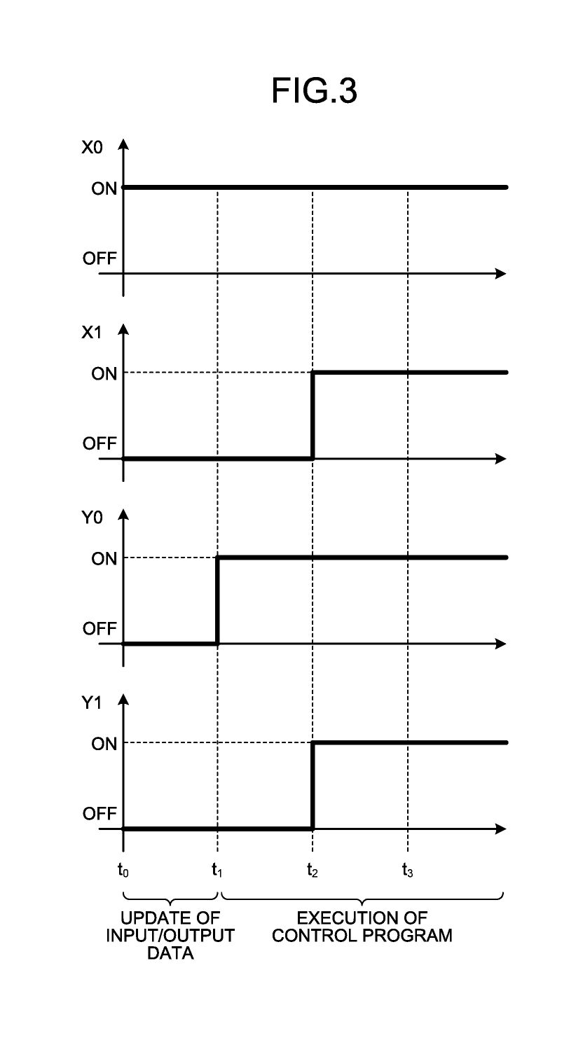

Next, an operation specification example of the apparatus 14 will be described. FIG. 3 is a diagram illustrating the operation specification example of the apparatus according to the embodiment. FIG. 3 illustrates a timing chart of input/output data described in the operation specifications of the apparatus 14. In FIG. 3, the horizontal axis represents time and the vertical axes represent input data X0 and X1 as well as output data Y0 and Y1.

The operation specifications of the apparatus 14 include update of the input/output data and execution of the control program. The control program in the operation specifications of the apparatus 14 includes two instructions. The control program used by the PLC 15 is created in accordance with the operation specifications of the apparatus 14. A first example of the instructions included in the operation specifications here is an instruction to turn ON the output datum Y0 if the input datum X0 taken at time of updating the input/output data is ON. A second example of the instructions included in the operation specifications here is an instruction to turn ON the output datum Y1 if the input datum X1 in the input/output device 16 is ON when the instruction of the control program is executed. The control program used by the PLC 15 includes the instructions of the first and second examples described above. This makes it possible to achieve the operation specifications of the apparatus 14 with the control program.

When the control program is executed, the input datum X0 is ON at time t₁, and therefore, the output datum Y0 is turned ON. When the control program is executed, the input datum X1 is OFF at time t₁, and therefore, the output datum Y1 remains OFF. When the input datum X1 is turned ON at time t₂, the output datum Y1 is turned ON.

From time t₀ to time t₁, the control unit 18 of the PLC 15 stores the input datum X0 from the input/output device 16 in the storage unit 17, and it transmits the output data stored in the storage unit 17 to the input/output device 16. As a result, the control unit 18 updates the input/output data from time t₀ to time t₁. In addition, from time t₁ to time t₃, the control unit 18 executes the control program with reference to the input/output data in the storage unit 17, and sequentially stores the output data as an execution result in the storage unit 17.

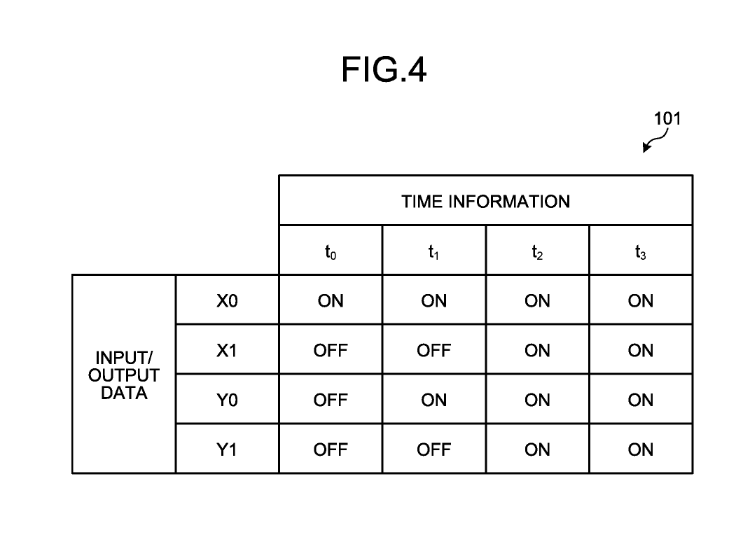

FIG. 4 is a diagram illustrating an example of the test pattern according to the embodiment. In FIG. 4, the test pattern 101 corresponding to the operation specifications illustrated in FIG. 3 is illustrated. The test pattern 101 is information that includes values of input/output data and time information as elements. The test pattern generation unit 12 of the verification apparatus 11 generates the test pattern 101 on the basis of the operation specifications illustrated in FIG. 3.

An example of the test pattern 101 is an information table in which the input/output data and the time information T2 are associated with each other. In the test pattern 101, the input data and the time information T2 are given as parameters. As a result, the test pattern 101 is defined by temporal changes in the input data.

As illustrated in FIG. 3, the input datum X0 remains ON from time t₀ to time t₃. Therefore, the input datum X0 of the test pattern 101 is set to ON at all of time t₀, time t₁, time t₂, and time t₃.

As illustrated in FIG. 3, the input datum X1 is OFF from time t₀ to just before time t₂, is turned ON at time t₂, and remains ON until time t₃. Therefore, the input datum X1 of the test pattern 101 is set to OFF at time t₀ and time t₁, and is set to ON at time t₂ and time t₃.

When performing the operation verification of the control program, the control unit 18 of the embodiment collates the time information T1 generated by the time information generation unit 19 with the time information T2 in the test pattern 101, and determines values of the input data X0 and X1 to be referred to. Specifically, the control unit 18 extracts, from the test pattern 101, the time information T2 that matches the time information T1 or the time information T2 closest to the time information T1. Then, the control unit 18 extracts the values of the input data X0 and X1 corresponding to the extracted time information T2 from the test pattern 101, and stores the values in the input data storage area 23.

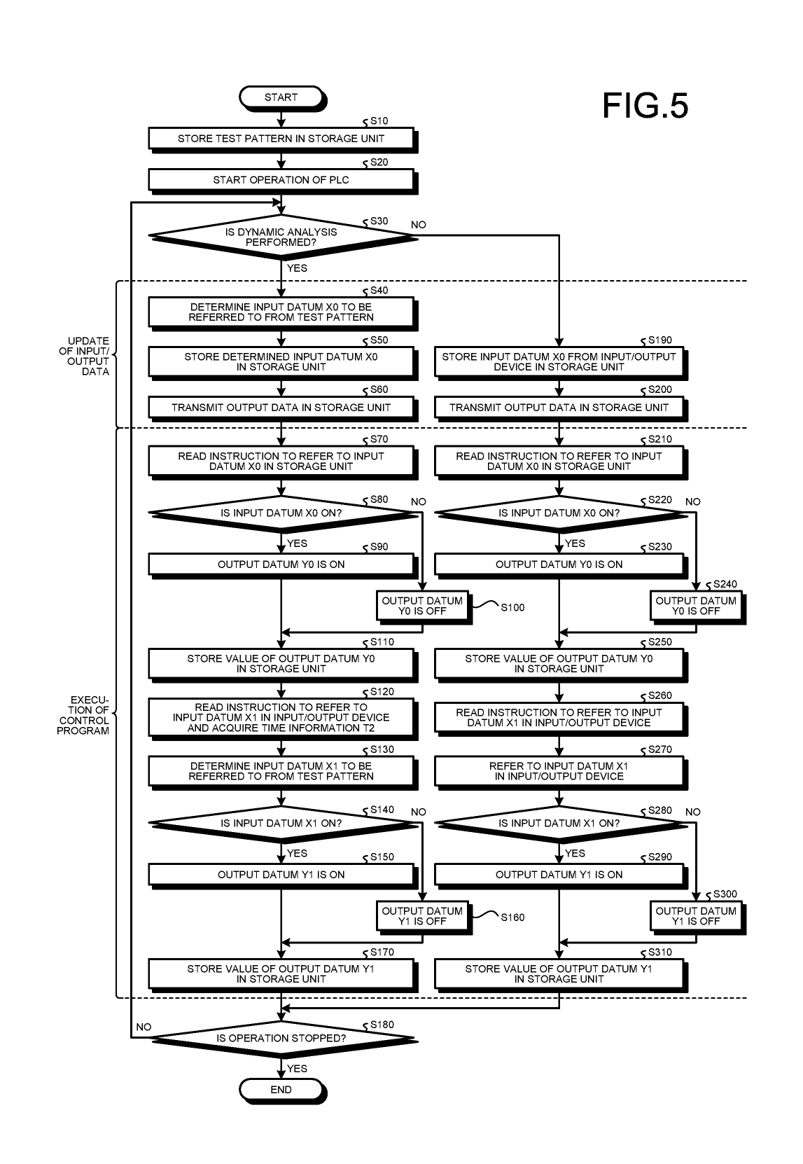

FIG. 5 is a flowchart illustrating an operation procedure of the PLC according to the embodiment. Here, an example of the operation of the PLC 15 in a case where the control program that determines the values of the output data Y0 and Y1 depending on the values of the input data X0 and X1 is stored in the PLC 15 will be described.

When the program verification system 10 performs the dynamic analysis which is the operation verification of the control program, an indication to perform the dynamic analysis of the control program is input to the PLC 15 by the user. Upon receiving this indication, the control unit 18 of the PLC 15 stores, in the parameter storage area 22, an operation setting parameter indicating that the dynamic analysis of the control program is performed. On the other hand, when the program verification system 10 performs the normal operation of the control program, an indication to perform the normal operation of the control program is input to the PLC 15 by the user. Upon receiving this indication, the control unit 18 of the PLC 15 stores, in the parameter storage area 22, an operation setting parameter indicating that the normal operation of the control program is performed.

When the test pattern 101 is sent to the PLC 15 from the test pattern generation unit 12 of the verification apparatus 11, the control unit 18 stores the test pattern 101 in the test pattern storage area 21 of the storage unit 17 in Step S10. The PLC 15 may perform the storage process of the test pattern 101 and the storage process of the operation setting parameter in either order.

When the PLC 15 starts its operation in Step S20, the control unit 18 determines whether to perform the dynamic analysis of the control program in Step S30. Specifically, the control unit 18 refers to the operation setting parameter stored in the parameter storage area 22, and determines whether to perform the dynamic analysis on the basis of the operation setting parameter.

When the dynamic analysis is performed, that is, when it is determined to be Yes in Step S30, the control unit 18 updates the input/output data and executes the control program. When updating the input/output data, the control unit 18 determines the input datum X0 to be referred to from the test pattern 101 in Step S40. In Step S50, the control unit 18 stores the determined input datum X0 in the test pattern storage area 21 of the storage unit 17. In other words, the control unit 18 rewrites a value of the input data stored in the storage unit 17 to the value of the input datum X0 in the test pattern 101. Specifically, the control unit 18 collates the time information T1 generated by the time information generation unit 19 with the time information T2 in the test pattern 101 to determine the input datum X0 to be applied to the control program. At that time, the control unit 18 extracts the time information T2 that is the same information on time as the time information T1 from the test pattern 101, and extracts the input datum X0 associated with the extracted time information T2 from the test pattern 101. Then, the control unit 18 determines the extracted input datum X0 as an input datum X0 to be stored in the storage unit 17.

After storing the input datum X0, the control unit 18 transmits the output data stored in the output data storage area 24 of the storage unit 17 to the collation unit 13 of the verification apparatus 11 in Step S60. Here, the control unit 18 transmits, to the collation unit 13, output data as an execution result obtained by executing, among instructions of the control program, an instruction immediately preceding an instruction about to be executed. In that case, the control unit 18 associates the output data stored in the storage unit 17 with the input data used in the immediately preceding instruction and stored in the storage unit 17, and transmits the output data and the input data to the collation unit 13. That is, the control unit 18 associates the output data with the input data used for calculating the output data and sends the output data and the input data to the collation unit 13. Specifically, the control unit 18 sends a set of the immediately preceding input data in the input data storage area 23 and the latest output data in the output data storage area 24. The processes in Steps S40 to S60 described above represent an update process of the input/output data when the dynamic analysis is performed.

In the update process of the input/output data when performing the dynamic analysis, the control unit 18 may extract all of the input data from the test pattern 101, or may extract a part of the input data from the test pattern 101 and acquire other input data from the input/output device 16. Which input data is to be extracted from the test pattern 101 is determined by the setting of the operation setting parameter performed by the user.

After performing the update of the input/output data, the control unit 18 executes the control program stored in the control program storage area 25 of the storage unit 17. The control program is configured to include a plurality of instructions, and the control unit 18 sequentially reads and executes the instructions in the control program. The instructions in the control program include some referring to the input datum X0 stored in the storage unit 17 and some referring to the input datum X1 in the input/output device 16. When performing the dynamic analysis, the control unit 18 collates the time information T1 generated by the time information generation unit 19 with the test pattern 101, and determines and reads the input data X0 and X1 to be referred to.

After reading the input datum X0, the control unit 18 executes an instruction in the control program and stores output data obtained by the execution in the output data storage area 24 of the storage unit 17. Here, a case where the control unit 18 dynamically analyzes the control program corresponding to the operation specifications illustrated in FIG. 3 will be described.

When the control unit 18 reads, from the control program, an instruction to refer to the input datum X0 in the storage unit 17 in Step S70, the control unit 18 reads the input datum X0 stored in the input data storage area 23 of the storage unit 17. The control unit 18 executes the control program with reference to the read input datum X0. As a result, the control program calculates the output datum Y0 corresponding to the input datum X0.

Here, the control unit 18 determines whether the input datum X0 is ON in Step S80. When the input datum X0 is ON, that is, when it is determined to be Yes in Step S80, the control unit 18 determines in Step S90 that the output datum Y0 is ON by using the control program. On the other hand, when the input datum X0 is OFF, that is, when it is determined to be No in Step S80, the control unit 18 determines in Step S100 that the output datum Y0 is OFF by using the control program. As described above, the control unit 18 calculates the output datum Y0 corresponding to the input datum X0 by executing the control program. Thereafter, in Step S110, the control unit 18 stores a value of the output datum Y0 that is an execution result in the output data storage area 24 of the storage unit 17.

When the control unit 18 reads, from the control program, an instruction to refer to the input datum X1 in the input/output device 16 in Step S120, the control unit 18 extracts, from the test pattern 101, the time information T2 that is the same information on time as the time information T1 generated by the time information generation unit 19, thereby acquiring the time information T2. That is, if there is an instruction to refer to the input datum X1, the control unit 18 acquires the time information T1 at that timing and acquires the time information T2 corresponding to the time information T1. In Step S130, the control unit 18 determines the input datum X1 to be referred to from the test pattern 101 on the basis of the time information T2. Then, the control unit 18 reads the input datum X1 registered in the test pattern 101. As described above, in the embodiment, if there is an instruction to refer to the input datum X1 in the input/output device 16 when the control unit 18 executes the dynamic analysis, the control unit 18 reads the input datum X1 registered in the test pattern 101. Then, the control unit 18 executes the control program with reference to the read input datum X1. As a result, the control program calculates the output datum Y1 corresponding to the input datum X1.

Here, the control unit 18 determines whether the input datum X1 is ON in Step S140. When the input datum X1 is ON, that is, when it is determined to be Yes in Step S140, the control unit 18 determines in Step S150 that the output datum Y1 is ON by using the control program. On the other hand, when the input datum X1 is OFF, that is, when it is determined to be No in Step S140, the control unit 18 determines in Step S160 that the output datum Y1 is OFF by using the control program. As described above, the control unit 18 calculates the output datum Y1 corresponding to the input datum X1 by executing the control program.

Thereafter, in Step S170, the control unit 18 stores a value of the output datum Y1 that is an execution result in the output data storage area 24 of the storage unit 17. The processes in Steps S70 to S170 described above represent an execution process of the control program when the dynamic analysis is performed.

In Step S180, the control unit 18 determines whether to stop the operation of the PLC 15 on the basis of an indication from the user. The control unit 18 does not stop the operation of the PLC 15 unless an indication to stop the operation is input to the PLC 15 by the user. When the operation of the PLC 15 is not stopped, that is, when it is determined to be No in Step S180, the control unit 18 returns to Step S30 and determines whether to perform the dynamic analysis of the control program. When the dynamic analysis is performed, that is, when it is determined to be Yes in Step S30, the control unit 18 performs the processes in Steps S40 to S180.

In Step S180, the control unit 18 repeats the processes in Steps S30 to S170 until the control unit 18 determines to stop the operation of the PLC 15. When the control unit 18 determines in Step S180 to stop the operation of the PLC 15, that is, when it is determined to be Yes in Step S180, the control unit 18 stops the operation of the PLC 15. As described above, after completing the execution of the control program, the control unit 18 repeats the update of the input/output data and the execution of the control program until receiving the indication to stop the operation.

When the dynamic analysis is not performed, that is, when it is determined to be No in Step S30, the control unit 18 updates the input/output data and executes the control program similarly to the case of performing the dynamic analysis. When the dynamic analysis is not performed, the control unit 18 performs a normal control operation to the input/output device 16. In that case, the control unit 18 stores the input datum X0 read from the input/output device 16 in the input data storage area 23 of the storage unit 17 in Step S190.

After storing the input datum X0, the control unit 18 transmits the output data stored in the output data storage area 24 of the storage unit 17 to the input/output device 16 in Step S200. Here, the control unit 18 transmits, to the input/output device 16, output data that is an execution result obtained by executing, among instructions of the control program, an instruction immediately preceding an instruction about to be executed. The processes in Steps S190 to S200 described above represent an update process of the input/output data when the normal operation is performed.

After performing the update of the input/output data, the control unit 18 executes the control program stored in the control program storage area 25 of the storage unit 17. After reading the input datum X0 from the input/output device 16, the control unit 18 executes an instruction in the control program and stores output data obtained by the execution in the output data storage area 24 of the storage unit 17. Here, a case where the control unit 18 executes the control program corresponding to the operation specifications illustrated in FIG. 3 will be described. In the following description, regarding a process among processes performed when the normal operation is performed, the process being similar to a process performed when the dynamic analysis is performed, the description thereof may be omitted.

When performing the normal operation using the control program, the control unit 18 performs processes in Steps S210 to S250, which are processes similar to those in Steps S70 to S110. When the control unit 18 reads an instruction to refer to the input datum X1 in the input/output device 16 from the control program in Step S260, the control unit 18 refers to the input datum X1 in the input/output device 16 in Step S270. Thereafter, the control unit 18 performs processes in Steps S280 to S310, which are processes similar to those in Steps S140 to S170.

In Step S180, the control unit 18 determines whether to stop the operation of the PLC 15 on the basis of an indication from the user. The control unit 18 does not stop the operation of the PLC 15 unless an indication to stop the operation is input to the PLC 15 by the user. When the operation of the PLC 15 is not stopped, that is, when it is determined to be No in Step S180, the control unit 18 returns to Step S30 and determines whether to perform the dynamic analysis of the control program. When the dynamic analysis is not performed, that is, when it is determined to be No in Step S30, the control unit 18 performs processes in Steps S190 to S310 and Step S180.

The control unit 18 repeats the processes in Steps S190 to S310 and Step S180 until the control unit 18 determines to stop the operation of the PLC 15 in Step S180. When the control unit 18 determines in Step S180 to stop the operation of the PLC 15, that is, when it is determined to be Yes in Step S180, the control unit 18 stops the operation of the PLC 15. As described above, after completing the execution of the control program, the control unit 18 repeats the update of the input/output data and the execution of the control program until receiving the indication to stop the operation.

When performing the dynamic analysis, the control unit 18 may sequentially transmit the input/output data to the collation unit 13, or may transmit, at fixed intervals, the input/output data after storing the input/output data in the storage unit 17.

The collation unit 13 collates the input data X0 and X1 as well as the output data Y0 and Y1 sent from the PLC 15 with the operation specifications of the apparatus 14, thereby verifying whether the control program is designed in accordance with the operation specifications. In that case, the collation unit 13 may collate the input/output data sent from the PLC 15 with the operation specifications of the apparatus 14 illustrated in FIG. 3, or may collate the input/output data sent from the PLC 15 with the test pattern 101 illustrated in FIG. 4.

Here, a difference between a case where the operation verification of the control program is performed using an actual apparatus such as the apparatus 14 or a facility, and the operation verification of the control program by the program verification system 10 will be described.

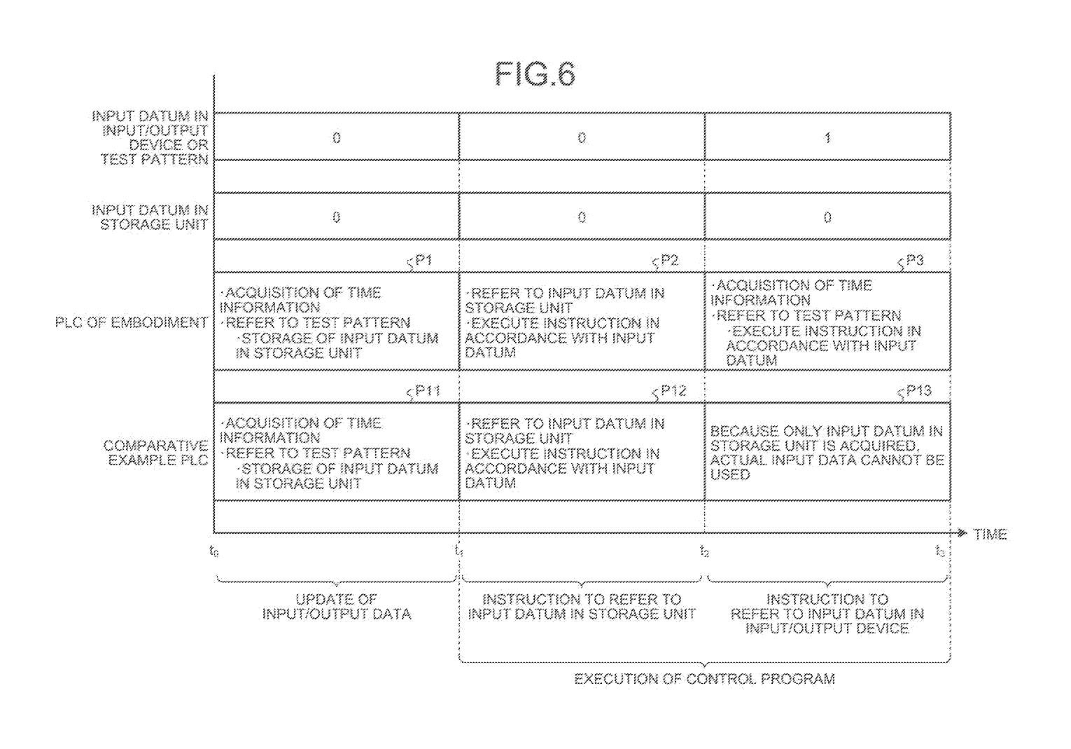

FIG. 6 is a diagram for explaining a difference between operation verification using an actual machine and operation verification according to the embodiment. In FIG. 6, a verification process of a comparative example using an actual machine such as the apparatus 14 and a verification process by the program verification system 10 are illustrated. Here, for convenience of explanation, the PLC according to the embodiment is referred to as the PLC 15, and a PLC that performs operation verification using an actual machine is referred to as a comparative example PLC. A storage unit included in the comparative example PLC is referred to as a comparative example storage unit. The comparative example storage unit corresponds to the storage unit 17 included in the PLC 15.

Control of the apparatus 14 by the PLC 15 and the comparative example PLC includes two steps: a step of updating the input/output data and a step of executing the control program. The control program used by the PLC 15 and the comparative example PLC for controlling the apparatus 14 includes a group of instructions including a plurality of instructions.

The PLC 15 and the comparative example PLC perform the process of updating the input/output data from time t₀ to time t₁. In addition, the PLC 15 and the comparative example PLC execute the control program from time t₁ to time t₃. In that case, the PLC 15 and the comparative example PLC attempt to execute an instruction to refer to the input datum X0 in the storage unit 17 from time t₁ to time t₂, and they attempt to execute an instruction to refer to the input datum X1 in the input/output device 16 from time t₂ to time t₃.

The input datum X1 stored in the input/output device 16 changes with time. On the other hand, the input datum X1 stored in the storage unit 17 changes at timing of an update process of the input/output data and does not change at the time of executing the control program. Therefore, when the storage unit 17 and the comparative example storage unit each store “0” as the input datum X1 at the time of the update process of the input/output data, the input datum X1 stored in each of the storage unit 17 and the comparative example storage unit remains to be “0” even when the control program is executed.

With respect to such input datum X1, the PLC 15 of the embodiment performs the operation verification using time information at time t₀ to time t₃, whereas the comparative example PLC performs the operation verification using time information at time t₀.

In the embodiment, with respect to the timing at which there is an instruction to refer to the input datum X1 in the input/output device 16, the test pattern generation unit 12 sets the same input datum X1 as the input datum X1 stored in the input/output device 16 in the test pattern 101. That is, the input datum X1 set in the test pattern 101 changes with time similarly to the input datum X1 stored in the input/output device 16. Therefore, when the input datum X1 in the input/output device 16 from time t₂ to time t₃ is “1”, the input datum X1 of the test pattern 101 from time t₂ to time t₃ is also “1”. On the other hand, the comparative example PLC can refer only to the input datum X1 in the comparative example storage unit. Hereinafter, Processes P1 to P3 performed by the PLC 15 of the embodiment and Processes P11 to P13 performed by the comparative example PLC will be described. Processes P1 and P11 are processes performed from time t₀ to time t₁, Processes P2 and P12 are processes performed from time t₁ to time t₂, and Processes P3 and P13 are processes performed from time t₂ to time t₃.

(Process P1)

In the step of updating the input/output data, the PLC 15 of the embodiment acquires the time information T2 by using the time information generation unit 19. Then, the PLC 15 refers to the test pattern 101 on the basis of the time information T2, thereby extracting the input datum X0 corresponding to the time information T2. Furthermore, the PLC 15 stores, in the storage unit 17, the input datum X0 extracted from the test pattern 101.

(Process P2)

If there is an instruction to refer to the input datum X0 in the storage unit 17 in the step of executing the control program, the PLC 15 refers to the input datum X0 in the storage unit 17 and executes the instruction in accordance with the input datum X0.

(Process P3)

If there is an instruction to refer to the input datum X1 in the input/output device 16 in the step of executing the control program, the PLC 15 acquires the time information T2 by using the time information generation unit 19. Then, the PLC 15 refers to the test pattern 101 on the basis of the time information T2, thereby extracting the input datum X1 corresponding to the time information T2. Furthermore, the PLC 15 executes the instruction in accordance with the input datum X1 extracted from the test pattern 101. As a result, the process of Process P3 is completed.

Because the input datum X1 in the test pattern 101 has the same value as the input datum X1 stored in the input/output device 16, the PLC 15 can perform an operation similar to the operation using the input/output device 16. As described above, because the test pattern 101 is stored in the storage unit 17, the PLC 15 can refer to correct input data at time t₂. In addition, since the PLC 15 reads the input datum X1 from the test pattern 101 in the storage unit 17 and stores the input datum X1 in the storage unit 17, communication time between the PLC 15 and the verification apparatus 11 is unnecessary at the time of the operation verification.

(Process P11)

In the step of updating the input/output data, the comparative example PLC acquires time information at time t₀. Thereafter, the comparative example PLC refers to the test pattern on the basis of the time information at time t₀, thereby extracting the input datum X0 corresponding to the time information at time t₀. Furthermore, the comparative example PLC stores the input datum X0 extracted from the test pattern in the comparative example storage unit. In that case, the test pattern referred to by the comparative example PLC corresponds to the time information at time t₀. The input datum X0 at time t₀ in the test pattern that is used by the comparative example PLC and the input datum X0 at time t₀ in the test pattern 101 that is used by the PLC 15 according to the embodiment are the same. Therefore, the PLC 15 and the comparative example PLC can obtain similar verification results in Process P1 and Process P11.

(Process P12)

If there is an instruction to refer to the input datum X0 in the comparative example storage unit in the step of executing the control program, the comparative example PLC refers to the input datum X0 in the comparative example storage unit and executes the instruction in accordance with the input datum X0. In that case, the input data in the storage unit 17 and the comparative example storage unit are not updated from time t₁ to time t₃. Therefore, the input datum X0 at time t₁ in the test pattern that is used by the comparative example PLC and the input datum X0 at time t₁ in the test pattern 101 that is used by the PLC 15 according to the embodiment are the same. Therefore, similar verification results can be obtained in Process P2 and Process P12 in the PLC 15 and the comparative example PLC.

(Process P13) As described above, when the comparative example PLC stores “n” as the input datum X1 in the comparative example storage unit at time t₀ which is an update process of the input/output data, the input datum X1 stored in the comparative example storage unit remains to be “0” even when the control program is executed. Consequently, even if there is an instruction to refer to the input datum X1 in the input/output device 16 in the step of executing the control program, the comparative example PLC can acquire only the input datum X0 in the comparative example storage unit. Therefore, the comparative example PLC cannot use the input datum X1 that is the actual input data in the input/output device 16. That is, when the comparative example PLC executes an instruction to refer to the input datum X1 in the input/output device 16, the comparative example PLC has only the input datum X0 at time t₀ when communication with the verification apparatus 11 is performed, and thus it is impossible to refer to correct input datum X1. As described above, because the comparative example PLC keeps the input data X0 and X1 at time t₀ stored in the storage unit, even when the verification is performed at time t₂, only the input data X0 and X1 at the time t₀ can be used. Consequently, the comparative example PLC cannot perform the operation verification with accuracy similar to that obtained with the actual machine. Because the input/output device 16 is not operating, the comparative example PLC cannot read the input datum X1 from the input/output device 16.

When the verification apparatus 11 transmits the input datum X1 as verification data to the comparative example PLC at the time of the operation verification, a communication process occurs between the verification apparatus 11 and the comparative example PLC. Consequently, the comparative example PLC cannot operate at timing similar to that in the actual operation at the time of the operation verification. As a result, the verification apparatus 11 cannot correctly verify the input/output data used by the comparative example PLC.

In a case where a computer performs operation verification of the control program by simulation, man-hours for constructing a virtual environment used for the simulation increases and the verification in real time cannot be performed. Consequently, it takes a long time to perform the verification. Furthermore, in the case where the computer performs the operation verification of the control program by simulation, it is impossible to confirm whether the input/output data transitions at timing similar to that in the actual machine, similarly to the operation verification using the actual machine described above.

On the other hand, the PLC 15 stores the test pattern 101 that is data for operation verification in the storage unit 17, and it calculates output data Y0 and Y1 that can be obtained as a result of the operation of the PLC 15 with reference to the input data X0 and X1 in the test pattern 101. Then, the verification apparatus 11 collates the operation specifications of the apparatus 14 with the calculated output data Y0 and Y1. In other words, the verification apparatus 11 collates the output data in the test pattern 101 with the calculated output data Y0 and Y1. This makes it possible to verify whether the input data X0 and X1 as well as the output data Y0 and Y1 transition at timing similar to that in the actual apparatus 14.

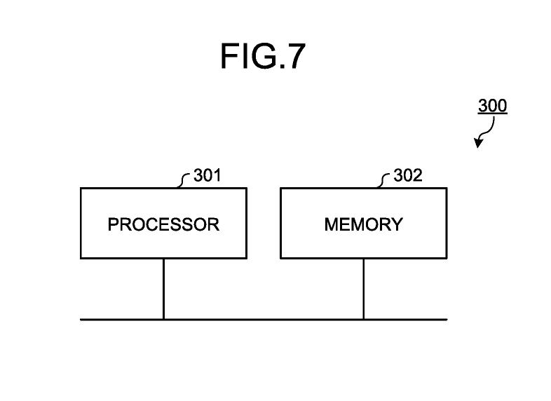

Here, a hardware configuration of the control unit 18 will be described. FIG. 7 is a diagram illustrating an example hardware configuration of the control unit included in the PLC according to the embodiment. The control unit 18 can be realized as a control circuit 300 illustrated in FIG. 7, that is, a processor 301 and a memory 302. Examples of the processor 301 include a central processing unit (CPU, also referred to as central processing device, processing device, arithmetic device, microprocessor, microcomputer, processor, and DSP), and system large scale integration (LSI). Examples of the memory 302 include a random access memory (RAM), a read only memory (ROM), and a flash memory.

The control unit 18 is realized as the processor 301 reading and executing a program stored in the memory 302 for performing an operation of the control unit 18. It can also be said that the program causes the computer to execute procedures or methods of the control unit 18. The memory 302 is also used as a temporary memory when the processor 301 performs various processes.

As described above, the program executed by the processor 301 is a computer program product having a computer readable and non-transitory recording medium including a plurality of instructions for executing data processing, which can be executed by the computer. The program executed by the processor 301 causes the computer to execute data processing by a plurality of instructions.

The control unit 18 may be realized as dedicated hardware. A part of the functions of the control unit 18 may be realized by dedicated hardware and another part thereof may be realized by software or firmware.

Similarly to the control unit 18, the test pattern generation unit 12 and the collation unit 13 of the verification apparatus 11 can also be realized as the control circuit 300 illustrated in FIG. 7, that is, the processor 301 and the memory 302.

As described above, in the embodiment, the PLC 15 stores the test pattern 101 including the time information T2 in advance, and extracts the input data X0 and X1 from the test pattern 101 on the basis of the generated time information T1. Then, the PLC 15 calculates the output data Y0 and Y1 using the control program and the extracted input data X0 and X1. Furthermore, the verification apparatus 11 collates the output data corresponding to the input data X0 and X1 in the test pattern 101 with the output data calculated by the PLC 15. This makes it possible for the program verification system 10 to verify whether the input/output data transitions at timing similar to that in the actual apparatus 14. Therefore, the program verification system 10 can easily perform accurate operation verification of the control program.

Because the PLC 15 stores the test pattern 101 in the storage unit 17 in the PLC 15, it is possible to rewrite a value of the input/output data in the PLC 15 at a high speed. Because the PLC 15 stores the test pattern 101 in the storage unit 17 in the PLC 15, there is no need to receive the input data X0 and X1 from the verification apparatus 11 at the time of the operation verification. This makes it possible for the program verification system 10 to perform the operation verification of the control program in a shorter period of time and with less man-hours. Therefore, it is possible to shorten a start-up period in developing a facility including the apparatus 14 or the PLC 15.

The configurations described in the embodiment above are merely examples of the content of the present invention and can be combined with other known technology and part thereof can be omitted or modified without departing from the gist of the present invention.

### REFERENCE SIGNS LIST

10 program verification system; 11 verification apparatus; 12 test pattern generation unit; 13 collation unit; 14 apparatus; 15 PLC; 16 input/output device; 17 storage unit; 18 control unit; 19 time information generation unit; 21 test pattern storage area; 22 parameter storage area; 23 input data storage area; 24 output data storage area; 25 control program storage area; 31, 32 communication IF unit; 101 test pattern.

1. A program verification system comprising:
a control apparatus to receive input of control input data from an input/output device that inputs and outputs data, to calculate control output data corresponding to the control input data by using a control program for controlling an apparatus to be controlled, and to output the control output data to the input/output device;
a first processor; and
a first memory to store a first program which, when executed by the first processor, performs steps of
performing operation verification of the control program by collating test output data included in a test pattern, which is a combination of test input data and the test output data satisfying operation specifications of the apparatus to be controlled and indicates a temporal change using time same as time in the control apparatus, with the control output data calculated by the control apparatus, wherein
the control apparatus comprises:
a second processor; and
a storage to store the test pattern and a second program which, when executed by the second processor, performs steps of;
when operation verification of the control program is performed, if there is an instruction to refer to the control input data in the control program, acquiring first time information that is information on time in the control apparatus, to extract the test input data corresponding to the first time information from the test pattern, and to calculate the control output data by using the extracted test input data and the control program.

2. The program verification system according to claim 1, wherein the first processor further generates the test pattern and sends the test pattern to the control apparatus.

3. The program verification system according to claim 1, wherein
the storage comprises:
a first storage to store the test pattern;
a second storage to store the control input data from the input/output device; and
a third storage to store the control output data to the input/output device;
the second processor,
if there is an instruction to refer to the control input data input from the input/output device in the control program when operation verification of the control program is performed, extracts the test input data from the test pattern on a basis of the first time information to store the test input data in the second storage, calculates the control output data by using the extracted test input data and the control program to store the control output data in the third storage, and transmits the test input data in the second storage and the control output data in the third storage to the first processor, and
the first processor performs the operation verification by using the test output data corresponding to the test input data from the second processor.

4. The program verification system according to claim 1, wherein
the second processor of the control apparatus further generates the first time information,
the test pattern is constituted of the test input data, the test output data, and second time information that is information on time corresponding to the first time information, which are associated with one another, and
the first processor collates the control output data calculated by the control apparatus with the test output data in the test pattern on a basis of the first time information and the second time information.

5. The program verification system according to claim 2, wherein the the first processor generates the test pattern on a basis of operation specifications of the apparatus to be controlled.

6. A control apparatus comprising:
a first transceiver to receive input of control input data from an input/output device that inputs and outputs data;
a processor;
a memory to store a program which, when executed by the processor, performs steps of
calculating control output data corresponding to the control input data by using a control program for controlling an apparatus; and
a second transceiver to output the control output data to the input/output device; wherein
the memory further stores a test pattern that is a combination of test input data and test output data satisfying operation specifications of the apparatus to be controlled and indicates a temporal change using time same as time in the control apparatus, wherein
the processor,
when operation verification of the control program is performed, if there is an instruction to refer to the control input data in the control program, generates first time information that is information on time in the control apparatus, extracts the test input data corresponding to the first time information from the test pattern, and calculates the control output data by using the extracted test input data and the control program.

7. The control apparatus according to claim 6, wherein the processor further performs operation verification of the control program by collating the control output data calculated with the test pattern,
and collates the control output data calculated by the control apparatus with the test output data in the test pattern.

8. A program verification method comprising:
storing, performed by a control apparatus to receive input of control input data from an input/output device that inputs and outputs data, to calculate control output data corresponding to the control input data by using a control program for controlling an apparatus, and to output the control output data to the input/output device, a test pattern, which is a combination of test input data and test output data satisfying operation specifications of the apparatus to be controlled and indicates a temporal change using time same as time in the control apparatus;
calculating, performed by the control apparatus, the control output data by, when operation verification of the control program is performed, if there is an instruction to refer to the control input data in the control program, generating first time information that is information on time in the control apparatus, extracting the test input data corresponding to the first time information from the test pattern, and using the extracted test input data and the control program; and
performing, performed by a verification apparatus to perform operation verification of the control program, operation verification of the control program by collating the control output data calculated by the control apparatus with the test output data in the test pattern.

9. The program verification system according to claim 2, wherein
the storage comprises:
a first storage to store the test pattern;
a second storage to store the control input data from the input/output device; and
a third storage to store the control output data to the input/output device;
the second processor,
if there is an instruction to refer to the control input data input from the input/output device in the control program when operation verification of the control program is performed, extracts the test input data from the test pattern on a basis of the first time information to store the test input data in the second storage, calculates the control output data by using the extracted test input data and the control program to store the control output data in the third storage, and transmits the test input data in the second storage and the control output data in the third storage to the first processor, and
the first processor performs the operation verification by using the test output data corresponding to the test input data from the second processor.

10. The program verification system according to claim 2, wherein
the second processor of the control apparatus further generates the first time information,
the test pattern is constituted of the test input data, the test output data, and second time information that is information on time corresponding to the first time information, which are associated with one another, and
the first processor collates the control output data calculated by the control apparatus with the test output data in the test pattern on a basis of the first time information and the second time information.

11. The program verification system according to claim 3, wherein
the second processor of the control apparatus further generates the first time information,
the test pattern is constituted of the test input data, the test output data, and second time information that is information on time corresponding to the first time information, which are associated with one another, and
the first processor collates the control output data calculated by the control apparatus with the test output data in the test pattern on a basis of the first time information and the second time information.

12. The program verification system according to claim 9, wherein
the second processor of the control apparatus further generates the first time information,
the test pattern is constituted of the test input data, the test output data, and second time information that is information on time corresponding to the first time information, which are associated with one another, and
the first processor collates the control output data calculated by the control apparatus with the test output data in the test pattern on a basis of the first time information and the second time information.
